(19) United States
(12) Patent Application Publication
(10) Pub. No.: US 2006/0233967 A1
(43) Pub. Date: Oct. 19, 2006

(54) Method and apparatus for forming fine lines by means of curing coating

(75) Inventors: Wen-Bin Lai, Hsinchu (TW); Yao-Hui Lu, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 11/106,551

(22) Filed: Apr. 15, 2005

(51) Int. Cl. B05D 3/12; C08F 2/46; B05C 1/00

(52) U.S. Cl. 427/487; 427/355; 118/249; 118/642

(57) ABSTRACT

A method and apparatus for forming fine lines by means of a curing coating is to use a first impressing wheel and second wheel in a sequence to impress respectively first spread zones and second spread zones with a curing coating on a carrier to form first lines zones and second lines zones; overlapped zones thereof have the same lines as both of them to allow the overlapped zones of the first lines zones and the second lines zones to be formed with continuous lines to form no-slits continuous lines.

### FIELD OF THE INVENTION

The present invention relates to a method and apparatus for forming fine lines on a carrier, and more particularly to a method and apparatus for forming fine lines by means of a curing coating.

### DESCRIPTION OF RELATED ART

Taiwan patent No. 138,863 discloses the combination of a holographic film formation and printing process, in which fluid resin is spread on one face of a paper, and a holographic pattern is formed on the resin with a plastic mold. And an electron beam is illuminated to cause the fluid resin to be hardened to form a holographic pattern.

Taiwan patent No. 592,950 discloses a film solvent-resistant laser holographic pattern and manufacture thereof in which a plastic film is combined with a UV resin film to allow the UV resin film to be tightly stuck to a metal wheel engraved with a laser holographic pattern. The UV resin film tightly stuck to the metal wheel is illuminated with UV light to cause the resin film to be hardened and stuck tightly with the plastic film. And, the UV resin is then caused to be separate from the metal. Finally, the laser holographic pattern is reproduced on the UV resin.

The U.S. Patent Pub. No. 20040241404 discloses a paper with holographic pattern and manufacture of it also mentions that a UV resin is tightly stuck with a metal wheel engraved with a laser holographic pattern and the laser holographic pattern is caused to reproduce on the UV resin layer by means of UV illumination.

The patents mentioned above disclose that the engraved wheel is used to stick with a curing coating and an electron beam or UV light is then illuminated to cause the curing coating to be hardened to form pattern lines.

Please refer to FIG. 1. A general simpler method for manufacturing an impression wheel is to stick an impression film 11 with lines onto the outer surface of a wheel 12 to form an impression wheel 10. The impression film 11 is wound around the wheel 12; a slit 111 is formed at the contact joint of the both ends thereof. As FIGS. 1 and 2 show, a corresponding slit is also yielded between lines 21 when the lines of impression wheel 10 is reproduced on a curing coating film 20 owing to the existence of the slit 111 so that a continuous lines pattern without a slit cannot be reproduced.

### SUMMARY OF THE INVENTION

For improving the defect that the corresponding slit will be yielded on a curing coating film when lines of a conventional engraved wheel stuck with a engraved film is reproduced onto the curing coating film, the present invention is proposed.

The main object of the present invention is to provide a method and apparatus for forming fine lines by means of a curing coating, allowing the lines reproduce onto a curing coating film without slits so as to enhance the manufacturing quality of the fine lines.

Another object of the present invention is to provide a method and apparatus for forming fine lines by means of a curing coating, capable of utilizing engraved wheels to manufacture a fine lines product without slits continuously so as to enhance the manufacturing efficiency.

### BRIEF DESCRIPTION OF THE DRAWINGS

The present invention can be more fully understood by reference to the following description and accompanying drawings, in which:

FIG. 1 is a schematic view, showing a conventional engraved wheel;

FIG. 2 is a schematic view, showing lines yielded on a curing coating film by the impression of a conventional wheel;

FIG. 3 is a schematic view, showing apparatus for forming fine lines according to a preferred embodiment of the present invention;

FIGS. 4A and 4B are schematic views, showing that a curing coating is impressed by a method according to the present invention; and

FIG. 5 is a schematic view, showing apparatus for forming fine lines according to another preferred embodiment of the present invention.

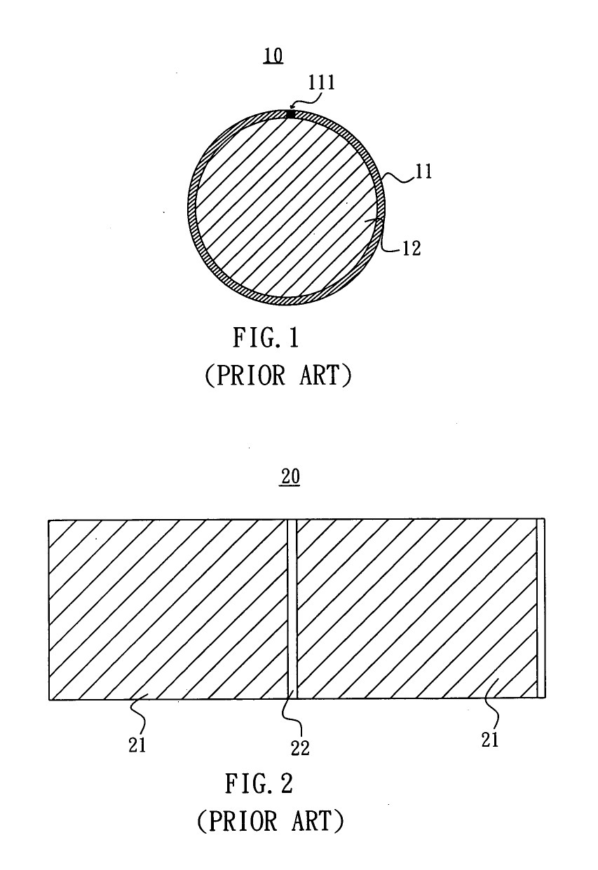

### DETAILED DESCRIPTION OF THE PREFERRED EMBODIMENTS

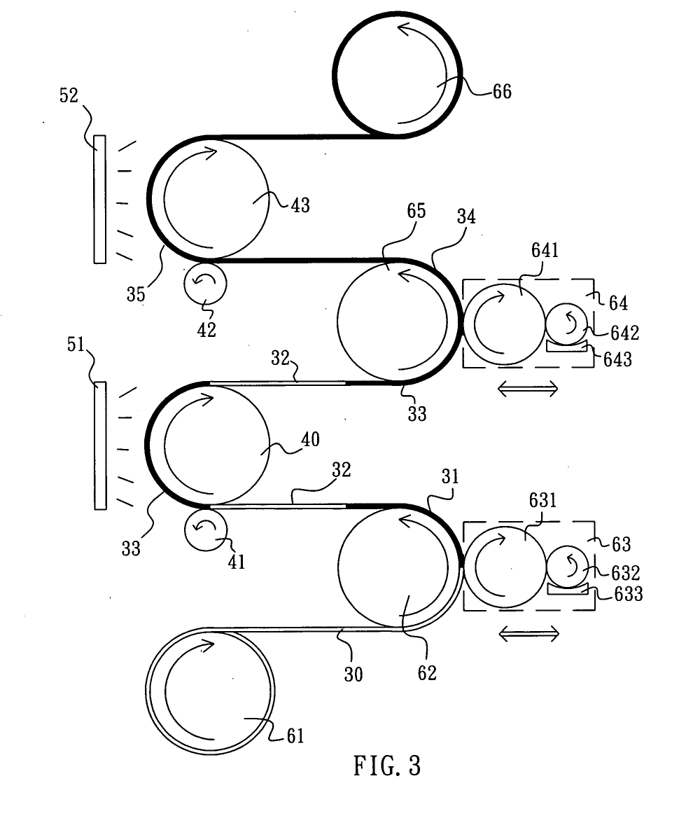

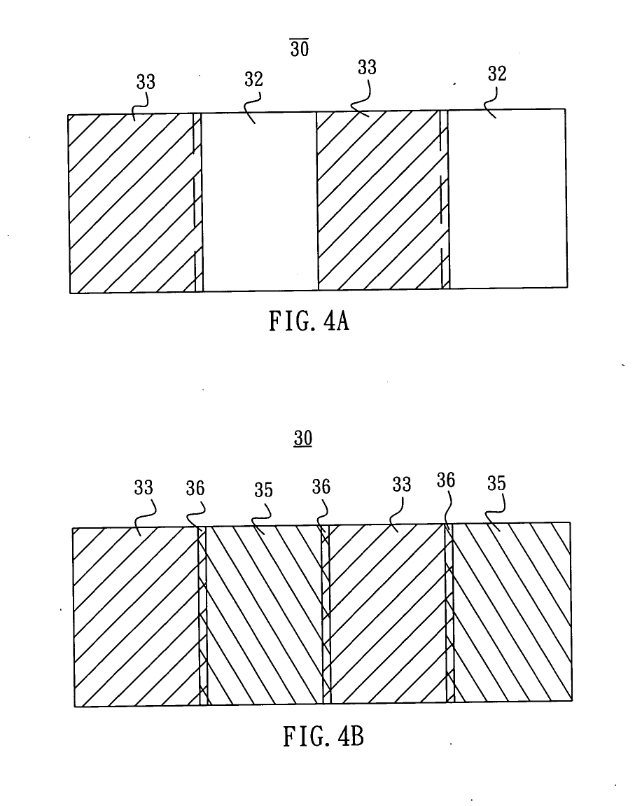

Please refer to FIGS. 3, 4A and 4B. A method for forming fine lines by means of a curing coating according to the present invention comprises the following steps:
(1) spreading a curing coating onto one face of a carrier 30 intermittently and forming first spread zones 31 and vacant zones 32 in which the length of the first spread zone 31 is longer than one half of the circumference of a first impressing wheel 40;
(2) pressing at least one pressing wheel from another face of the carrier 30 toward the first impressing wheel 40 to cause the first spread zone 31 of the carrier 30 to be stuck tightly with the first impression wheel 40 to allow lines corresponding to the lines of the first impression wheel 40 to be formed on the first spread zones 31 and then hardening said lines by the energy emitted from an illumination light emitting source 51 such as an electron beam or UV light to allow the carrier 30 to have first lines zones 33 intermittently, as FIG. 4A shows.
(3) Spreading the vacant zones 32 of the carrier 30 and the two adjacent first lines zones 33 of each vacant zone 32 with the curing coating to form a second spread zone 34, the length of the second spread zone 34 is also longer than on half of the circumference of the first impressing wheel 40; the both ends thereof has the overlapped zones over the adjacent first lines zones 33; and
(4) Pressing at least one pressing wheel 42 from another side of the carrier 30 toward the second impressing wheel 43 to cause the second spread zones 34 of the carrier 30 to be stuck tightly with the second impressing wheel 43 to allow lines corresponding to the lines of the second impressing wheel 44 to be formed on the second spread zones 34 and then hardening said lines with an electric beam or UV light emitted from another emitting source 52 to cause the second spread zones 34 of the carrier 30 to be formed to second lines zones 35, in which an overlapped zone 36 of the first lines zone 33 and the second lines zone 35 formed by the first spread zone 31 and the second spread zone 34 of the carrier 30 respectively impressed by the first impressing wheel 40 and the second impressing wheel 43 has same lines, continuous lines are caused to form on the overlapped zone 36 of the first lines zone 33 and the second lines zone 35 to form continuous non-slit lines, as FIG. 4B.

A plastic film or metal plate with lines is respectively stuck on the circumferences of the first impressing wheel 40 and the second impressing wheel 43 or lines is respectively fabricated on the circumferences of the first impressing wheel 40 and the second impressing wheel 43 such as a holographic laser impressing wheel disclosed in Taiwan Patent No. 549,744.

The curing coating used in the present invention can be an electron team or UV light curing coating. The light emitting source 54 can be an electron beam emitter or UV light to emit an electron beam or UV light.

A first preferred embodiment according to the present invention used to carry out the method mentioned above is to allow the one end of the long strip type carrier 30 to be wound around a roller wheel 61 and another end thereof contacts, turns and detours a first film carrying wheel 62, the first impressing wheel 40, a second film carrying wheel 65 and the second impressing wheel 43 in a sequence and is wound around and driven by another roller wheel 66. The roller wheel 66 is used to roll in the carrier 30 fabricated with the continuous lines in the embodiment.

A first mobile spreading mechanism 63 can be moved toward or separated from the first film carrying wheel 62 to touch or depart from another side of the carrier 30 contacted with the first film carrying wheel 62, as FIG. 3 shows. The first spreading mechanism 63 is constituted by pressing the first glue carrying wheel 631 against the second glue carrying wheel 632 and contacting the second glue carrying wheel 632 with curing coating in a glue tray 633. The curing coating stuck on the second glue carrying wheel 632 can be stuck onto the first glue carrying wheel 631. When the carrier 30 is sandwiched between the first glue carrying wheel 631 and the first film carrying wheel 62, the curing coating can be caused to spread onto the carrier 30 to form a first spread zone 31. When the first glue wheel 631 is separated from the carrier 30, the curing coating cannot then be spread on the carrier to form a vacant zone 32. The second glue wheel 632 is used to spread the curing coating first onto the first glue carrying wheel 631, and the first glue carrying wheel 631 is then used to spread into the carrier 30 to cause the curing coating to be spread onto the carrier 30 more uniformly. The first glue carrying wheel 631 can be omitted in the first spreading mechanism 63 and the second glue carrying wheel 632 can directly be used to spread the curing coating onto the carrier 30.

A second mobile spreading mechanism 64 can be moved toward or separated from the second film carrying wheel 65 to touch or depart from another side of the carrier 30 contacted with the second film carrying wheel 62, as FIG. 3 shows. The second spreading mechanism 64 allows the vacant zone 32 and the areas adjacent thereto of the carrier 30 to form the second spread zone 34. The structure of the second spreading mechanism 64 same as the one of the first spreading mechanism 63 also has a first glue carrying wheel 641, second glue wheel 642 and glue tray 643; the function thereof is also the same as the one of the first spreading mechanism 63, the only difference is to spread the curing coating onto the carrier 30 to form the second spread zones 34. The second spreading mechanism 64 can also omit the first glue carrying wheel 641 and the second glue carrying wheel 642 can directly be used to spread the curing coating onto the carrier 30.

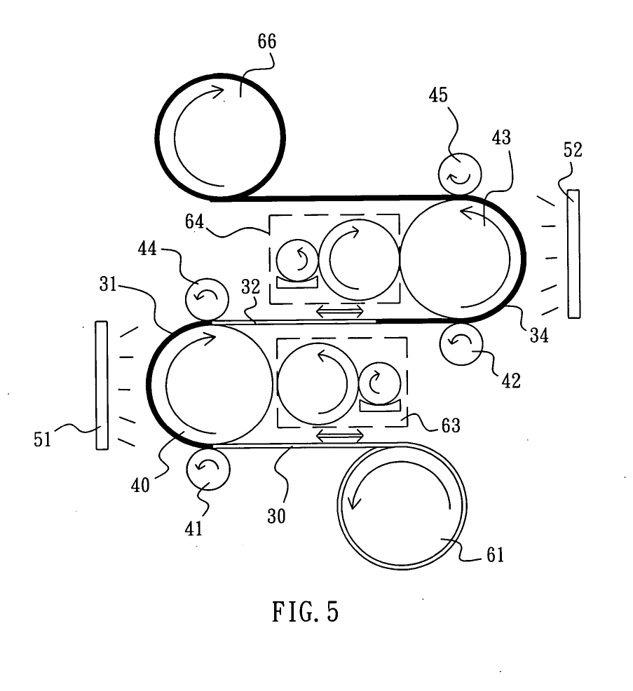

Please refer to FIG. 5. A second preferred embodiment according to the present invention used to carry out the method mentioned above is to allow the one end of the long strip type carrier 30 to be wound around a roller wheel 61 and another end thereof contacts, turns and detours the first impressing wheel 40, the second impressing wheel 43 in a sequence and is wound around and driven by another roller wheel 66. The roller wheel 66 is used to roll in the carrier 30 fabricated with the continuous lines in the embodiment.

One characteristic of the embodiment mentioned above is to allow the mobile first spreading mechanism 63 to contact discontinuously with the first impressing wheel 40, spread the curing coating onto the first impressing wheel 40 and then allow the curing coating to be stuck intermittently onto the carrier 30 to cause the carrier 30 to have the first spread zone 31 and the vacant zone 32. The pressing wheels 41 and 44 and the first impressing wheel 40 are used to sandwich the carrier 30 among them to cause the carrier 30 to be closely stuck with the first impressing wheel 40. The light emitting source 51 is utilized to illuminate an electron beam or UV light to cause the curing coating on the first spread zone 31 to be formed with lines and hardened, and combine stably with the carrier 30.

Another characteristic of the embodiment mentioned above is to allow the mobile second spreading mechanism 63 to contact discontinuously with the second impressing wheel 43, spread the curing coating onto the first impressing wheel 40 and then allow the curing coating to be stuck intermittently onto the carrier 30 to cause the carrier 30 to have the second spread zone 32. The pressing wheels 42 and 45 and the second impressing wheel 43 are used to sandwich the carrier 30 among them to cause the carrier 30 to be closely stuck with the second impressing wheel 43. The light emitting source 52 is utilized to illuminate an electron beam or UV light to cause the curing coating on the second spread zones 32 to be formed with lines and hardened, and combined stably with the carrier 30.

The method according to the present invention is utilized to improve the defect that the corresponding slits are formed on the curing coating film when the lines are transferred through a general impressing wheel of a plastic film or a metal with lines so that the slits will not be yielded on the lines transferred to the curing coating film so as to enhance the quality or the fabricated fine line, and the impressing is used to fabricate fine lines without slits and so as to enhance the production efficiency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for forming fine lines by means of a curing coating, comprising:
(1) spreading a curing coating onto one face of a carrier intermittently and forming first spread zone and vacant zone in which the length of said first spread zone is longer than one half of the circumference of a first impressing wheel and lines are disposed on the outside of said first impressing wheel;
(2) pressing at least one pressing wheel from another face of the carrier toward a first impressing wheel to cause said first spread zone of said carrier to be stuck tightly with said first impression wheel to allow lines corresponding to said lines of said first impression wheel to be formed on said first spread zone and then hardening the lines by the energy emitted from an illumination emitting source to have a first lines zone intermittently;
(3) spreading vacant zone of said carrier and the two adjacent first lines zone of each vacant zone with said curing coating to form second spread zone, wherein the length of said second spread zone is also longer than on half of the circumference of said first impressing wheel, the both ends thereof has the overlapped zones over said adjacent first lines zones; and
(4) pressing at least another one pressing wheel from another side of the carrier toward said second impressing wheel to cause said second spread zone to be stuck tightly with said second impressing wheel to allow lines corresponding to said lines of said second impressing wheel to be formed on said second spread zone and then hardening the lines with energy from another emitting source to cause said second spread zone of said carrier to be formed to a second lines zone, in which an overlapped zone of said first lines zone and said second lines zone formed by said first spread zone and said second spread zone of said carrier respectively impressed by said first impressing wheel and said second impressing wheel has same lines so that continuous lines are caused to form on said overlapped zone of said first lines zone and said second lines zone to form continuous non-slit lines.

2. The method according to claim 1, wherein spreading said carrier with a curing coating intermittently thereon by a mobile first spreading mechanism to form said first spread zone and said vacant zone in said step (1) and spreading said carrier with a curing coating thereon by another mobile second spreading zone to form said second spread zone in said step (3).

3. The method according to claim 1, wherein spreading a curing coating on said first impressing wheel intermittently by a mobile first spreading mechanism and then allowing said first impressing to contact with said carrier to cause said curing coating to be stuck on said carrier intermittently to form said first spread zone and said vacant zone on said carrier in said step (1) and spreading curing coating on said second impressing wheel intermittently by another mobile second spreading mechanism and then contacting said second impressing wheel with said carrier to allow said curing coating to be stuck onto said carrier intermittently to cause said carrier to have said second spread zones.

4. The method according to claim 1, wherein said curing coating is an UV curing coating; said light emitting source is an UV lamp and said emitted energy is UV light.

5. The method according to claim 1, wherein said curing coating is an electron beam curing coating; said light emitting source is an electron beam emitter and said emitted energy is an electron beam.

6. The method according to claim 1, wherein the circumferences of said first impressing wheel and said second impressing wheel are respectively stuck with one of a plastic film and metal plate with lines.

7. The method according to claim 2, wherein said curing coating is spread on said carrier when said carrier is sandwiched between a first film carrying wheel and said first spreading mechanism in said step (1) and said curing coating is spread on said carrier when said carrier is sandwiched between a second film carrying wheel and said second spreading mechanism in said step (3).

8. The method according to claim 3, wherein said first spreading mechanism comprises a first glue carrying wheel pressing against a second glue carrying wheel and said second glue carrying wheel contacts curing coating in a glue tray in said step (1) and said second spreading mechanism comprises a first glue carrying wheel pressing against a second glue carrying wheel and said second glue carrying wheel contacts curing coating in a glue tray in said step (3).

9. The method according to claim 7, wherein said first spreading mechanism comprises a first glue carrying wheel pressing against a second glue carrying wheel and said second glue carrying wheel contacts curing coating in a glue tray in said step (1) and said second spreading mechanism comprises a first glue carrying wheel pressing against a second glue carrying wheel and said second glue carrying wheel contacts curing coating in a glue tray in said step (3).

10. An apparatus for forming fine lines by means of a curing coating, being used to carry out the method according claim 9, comprising:
a first film wheel, first impressing wheel, second film wheel, second impressing wheel and roller wheel for allowing one end of a carrier to contact, turn and detour said first film carrying wheel, said first impressing wheel, said second film carrying wheel and said second impressing wheel in a sequence and being wound around and driven by said roller wheel;
a mobile first spreading mechanism adjacent to said first film carrying wheel for allowing a curing coating to be spread onto said carrier by said first spreading mechanism intermittently to form first spread zones and vacant zones;
at least one pressing wheel adjacent to said first impressing wheel for allowing said pressing wheel to be pressed against said first impressing wheel from another face of said carrier;
a light emitting source, being used for emitting energy to harden said curing coating on said first spread zones to cause first lines zones to be disposed on said carrier intermittently;
a mobile second spreading mechanism, adjacent to said second film carrying wheel for allowing each said vacant zone and said first lines zones adjacent thereto to be spread with a curing coating to form a second spread zone; and
another light emitting source, used to emit energy to cause said curing coating on said second spread zones to be hardened to allow second lines zones to be disposed on said carrier intermittently;
wherein same lines are disposed on an overlapped zone of said first lines zone and said second lines zone formed by being impressed on said first spread zone and second spread zone of said carrier respectively with said first impressing wheel and said second impressing wheel so as to cause said overlapped zone of said first lines zone and said second lines zone to be formed continuous lines so as to form no-slit continuous lines.

11. The apparatus according to claim 10, wherein said light emitting source is an UV lamp.

12. The apparatus according to claim 10, wherein said light emitting source is an electron beam emitter.

13. The apparatus according to claim 10, wherein said first spreading mechanism and said second spreading mechanism respectively comprise a glue carrying wheel and a glue tray so as to use said curing coating in said glue tray and cause said glue carrying wheel to touch said curing coating in said glue tray.

14. The apparatus according to claim 10, wherein the circumferences of said first impressing wheel and second impressing wheel are respectively stuck with one of a plastic film and metal plate with lines.

15. The apparatus according to claim 13, wherein said first glue carrying wheel is pressed against said second glue carrying wheel and said glue carrying wheel contacts with said curing coating in said glue tray respectively in said first spreading mechanism and said second spreading mechanism.

16. An apparatus for forming fine lines by means of a curing coating, being used to carry out the method according claim 8, comprising:
a first impressing wheel, second impressing wheel and roller wheel for allowing one end of a carrier to contact, turn and detour said first impressing wheel and second impressing wheel and being wound around and driven by said roller wheel;
a mobile first spreading mechanism adjacent to said first impressing wheel for allowing said first spreading mechanism to contact with said first impressing wheel intermittently to spread said a curing coating onto said first impressing wheel and then cause said curing coating to be stuck onto said carrier intermittently to allow first spread zones and vacant zones to be disposed on said carrier;
at least one pressing wheel adjacent to said first impressing wheel for pressing another face of said carrier toward said first impressing wheel;
a light emitting energy, used to emit energy to cause said curing coating on said first spread zones to be hardened to allow first lines zones to be disposed on said carrier intermittently;
a mobile second spreading mechanism adjacent to said second impressing wheel for causing said second spreading mechanism to contact with said second impressing wheel intermittently to spread said curing coating onto said second impressing wheel and then allowing said curing coating to be stuck onto each said vacant zone and said first lines zones adjacent thereof of said carrier intermittently to form second spread zones;
another light emitting source, used to emit energy to cause said curing coating on said second spread zones to be hardened to allow second lines zones to be disposed on said carrier intermittently;
wherein same lines are disposed on an overlapped zone of said first lines zone and said second lines zone formed by being impressed on said first spread zone and second spread zone of said carrier respectively with said first impressing wheel and said second impressing wheel so as to cause said overlapped zone of said first line zone and second line zone to be formed continuous lines so as to form no-slit continuous lines.

17. The apparatus according to claim 16, wherein said light emitting source is an UV lamp.

18. The apparatus according to claim 16, wherein said light emitting source is an electron beam emitter.

19. The apparatus according to claim 16, wherein said first spreading mechanism and said second spreading mechanism respectively comprise a glue carrying wheel and a glue tray so as to use said curing coating in said glue tray and cause said glue carrying wheel to touch said curing coating in said glue tray.

20. The apparatus according to claim 16, wherein the circumferences of said first impressing wheel and second impressing wheel are respectively stuck with one of a plastic film and metal plate with lines.

21. The apparatus according to claim 19, wherein said first glue carrying wheel is pressed against said second glue carrying wheel and said glue carrying wheel contacts with said curing coating in said glue tray respectively in said first spreading mechanism and said second spreading mechanism.
